(19) United States
(12) Patent Application Publication
(10) Pub. No.: US 2026/0054674 A1
(43) Pub. Date: Feb. 26, 2026

(54) DETECTION UNIT AND VEHICLE LOWER STRUCTURE

(71) Applicant: MITSUBISHI JIDOSHA KOGYO KABUSHIKI KAISHA, Tokyo (JP)

(72) Inventors: Lei LI, Tokyo (JP); Hideyuki YAJIMA, Tokyo (JP); Takayuki KOBAYASHI, Tokyo (JP); Shinya NISHIKADO, Tokyo (JP); Mondo SAITO, Tokyo (JP); Yoshihiro NAKAMURA, Okazaki-shi (JP); Toshisato MATSUI, Okazaki-shi (JP); Tomoyasu HIRAKAWA, Okazaki-shi (JP)

(73) Assignee: MITSUBISHI JIDOSHA KOGYO KABUSHIKI KAISHA, Tokyo (JP)

(21) Appl. No.: 19/103,278

(22) PCT Filed: Aug. 29, 2022
(86) PCT No.: PCT/JP2022/032349

§ 371 Date: Feb. 12, 2025

(51) Int. Cl. B60R 19/48; B60R 19/02; B60R 19/04

(52) U.S. Cl. CPC B60R 19/48; B60R 19/023; B60R 19/04

(57) ABSTRACT

A detection unit (5), which is attached to a rear bumper cover (2) of a vehicle and detects a kick motion of a user, includes: a sensor (10) that is disposed to oppose an inner surface (2A) of the rear bumper cover (2), extends in a vehicle width direction, and detects the kick motion; a controller (20) that processes a sensor signal; and a support member (30) that is fixed to the inner surface (2A) and supports the sensor (10) and the controller (30). The support member (30) includes a first surface portion (31) to which the sensor (10) and the controller (20) are attached and which extends along the inner surface (2A) in a fixed state, a second surface portion (32) that is positioned on a vehicle front side of the controller (20) and extends upward from a front end (31b) of the first surface portion (31) in the fixed state, and a third surface portion (33) that extends downward from an upper end (32a) of the second surface portion (32) and forms an erect wall (34) in a substantially inverted V shape with the second surface portion (32) in the fixed state.

### TECHNICAL FIELD

The present disclosure relates to a detection unit, which is attached to a rear bumper cover of a vehicle and detects a kick motion of a user, and to a vehicle lower structure including the detection unit.

### BACKGROUND TECHNIQUE

In some commercially available vehicles, electric motors automatically open and close tailgates (back doors) at rear surfaces of hatchback or minivan type vehicles. Such an electric tailgate is opened and closed by an electric motor operating in response to switch operation by a user or upon detecting a kick motion of a foot of the user. A detection unit (kick sensor, kick motion sensor) that detects the kick motion of the foot is often arranged at a lower portion of a rear bumper cover or on an undercover. For example, Patent Document 1 discloses a vehicle lower structure with a kick sensor arranged in a closed cross-sectional space surrounded by a rear floor cover, which is a type of undercover, and a rear bumper cover, thereby suppressing intrusion of foreign objects such as dirt, rain, and snow to prevent malfunction.

### PRIOR ART REFERENCE

### Patent Document

[Patent Document 1] JP 2019-127804 A

### SUMMARY OF INVENTION

### Problems to be Solved by Invention

Since the detection unit described above is disposed behind a rear wheel, there is a risk that foreign objects (hereinafter referred to as “flying stones”) such as stones and dirt churned up by the rear wheel during travel may fly toward the detection unit. The detection unit includes a controller that processes a signal from a sensor and thus requires a structure for protecting the controller from flying stones. In addition, traveling resistance increases due to oncoming wind entering the rear bumper cover, which has a risk of affecting fuel consumption and electricity consumption.

From these viewpoints, the detection unit is desired to satisfy two requirements: protecting the controller from flying stones (flying stones prevention requirement) and reducing traveling resistance (aerodynamic requirement). However, as in Patent Document 1, if an attempt is made to satisfy these two requirements by forming a closed cross-sectional space using a rear bumper cover and a rear floor cover, the structure would become larger and may lead to an increase in costs.

The present disclosure has been devised to solve the above-mentioned problems, and one of the objects thereof is to provide a detection unit and a vehicle lower structure capable of reducing costs while satisfying both the flying stones prevention requirement and the aerodynamic requirement. In addition to this object, it is also regarded as another object of the present disclosure to provide actions and effects which are derived from each configuration described in the following “Embodiment(s) to Carry out Invention” and which conventional technique does not attain.

### Means to Solve Problems of Invention

The disclosed detection unit and vehicle lower structure can be realized as an aspect or an application example disclosed below and solve at least a part of the above problems.

(1) A detection unit disclosed herein is attached to a rear bumper cover of a vehicle and detects a kick motion of a user, and includes: a sensor that is disposed to oppose an inner surface facing a vehicle inside of the rear bumper cover, extends in a vehicle width direction, and detects the kick motion; a controller that processes a signal from the sensor; and a support member that is fixed to the inner surface of the rear bumper cover and supports the sensor and the controller.

The support member includes a first surface portion to which the sensor and the controller are attached and which extends along the inner surface of the rear bumper cover in a fixed state, a second surface portion that is positioned on a vehicle front side of the controller and extends upward from a front end of the first surface portion in the fixed state, and a third surface portion that extends downward from an upper end of the second surface portion and forms an erect wall in a substantially inverted V shape with the second surface portion in the fixed state.

(2) Preferably, in the detection unit, the first surface portion, the second surface portion, and the third surface are integrally formed.

(3) Preferably, in the detection unit defined in (1) or (2) above, the support member includes a rib that connects mutually opposing surfaces of the second surface portion and the third surface portion to each other.

(4) Preferably, in this case, a plurality of the ribs are arranged at intervals in the vehicle width direction.

(5) Preferably, in the detection unit defined in any one of (1) to (4) above, the third surface portion includes an inclining surface arranged in a forward tilting posture such that a lower end thereof is positioned closer to a vehicle rear side than an upper end thereof.

(6) Preferably, in the detection unit defined in any one of (1) to (5) above, a vehicle width directional dimension of the erect wall is equal to or shorter than a half of a vehicle width directional dimension of the sensor.

(7) Preferably, in the detection unit defined in any one of (1) to (6) above, the rear bumper cover includes a decorative portion that is provided at a lower portion of a rear surface facing a vehicle rear side thereof and that forms a predetermined shape in a vehicle rear view, the support member is fixed to the inner surface on a reverse side of the decorative portion, and at least a portion of the sensor is disposed on the reverse side of the decorative portion.

(8) In addition, a vehicle lower structure disclosed herein includes the detection unit defined in (7) above, and the decorative portion of the rear bumper cover is provided as a convex portion or a concave portion forming the predetermined shape.

### Effects of Invention

According to the disclosed detection unit and the vehicle lower structure, it is possible to reduce costs while satisfying both the flying stones prevention requirement and the aerodynamic

### BRIEF DESCRIPTION OF DRAWINGS

FIG. 1 is a schematic left side view of a vehicle equipped with a detection unit and a vehicle lower structure according to an embodiment.

FIG. 2 is a view of a rear bumper cover of the vehicle of FIG. 1 as seen from a vehicle rear side.

FIG. 3 is a longitudinal cross-sectional view of the vehicle lower structure of FIG. 1 cut in a vehicle front-rear direction (a sectional view as seen from arrows X-X of FIGS. 2 and 4).

FIG. 4 is a view of the detection unit of FIG. 1 as seen from a vehicle front side.

FIG. 5 is an enlarged perspective view of an erect wall of the detection unit of FIG. 4.

### EMBODIMENT(S) TO CARRY OUT INVENTION

A detection unit and a vehicle lower structure according to an embodiment will now be described with reference to the drawings. The embodiment described below is merely an example and is not intended to exclude the application of various modifications or techniques not explicitly described in the following embodiment. The configurations of each embodiment can be variously modified without departing from the gist thereof. Further, the configurations can be selected as necessary or combined as appropriate.

In the following description, a forward direction of a vehicle is referred to as a front side (vehicle front side), left and right are defined with reference to the front side, and a left-right direction of the vehicle is referred to as a vehicle width direction.

The detection unit described in detail below detects a kick motion of a user, and the vehicle lower structure described in detail below relates to a portion to which the detection unit is attached and its surrounding area. Regarding definitions of directions in the embodiment, the directions relating to parts and portions that constitute the detection unit refer to the directions when the detection unit is mounted on a vehicle, unless otherwise specified.

### 1. Configuration

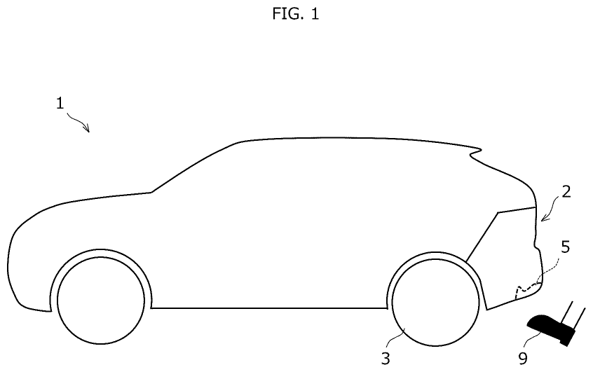

As illustrated in FIG. 1, a detection unit 5 according to an embodiment is attached to a rear bumper cover 2 of a vehicle 1 and detects that a user has performed a kick motion as if the user has held his or her foot 9 under the rear bumper cover 2. When the detection unit 5 detects the kick motion, a signal is sent to a non-illustrated electric motor and a tailgate (not depicted) automatically opens and closes.

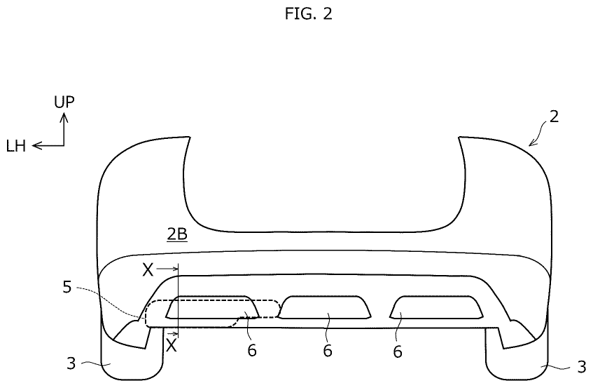

As illustrated in FIG. 2, the rear bumper cover 2 of the present embodiment includes a decorative portion 6 that is provided at a lower portion (skid plate portion) of a rear surface 2B facing a vehicle rear side and that forms a predetermined shape in a rear view. The decorative portion 6 enhances designability (design performance) of the rear bumper cover 2. In the vehicle 1 of the present embodiment, three decorative portions 6 each forming a horizontally elongated substantial trapezoid are arranged side by side in the vehicle width direction, and each of the decorative portions 6 is provided as a convex portion or a concave portion forming the predetermined shape (substantial trapezoid). As a result, the decorative portions 6 contribute to enhancing rigidity of the rear bumper cover 2 in addition to enhancing the designability.

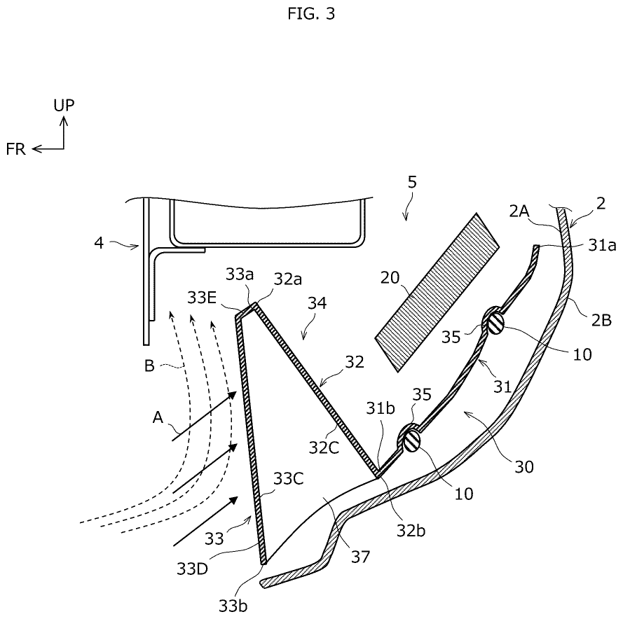

The detection unit 5 is attached to a reverse side of the decorative portion 6 on the left side, that is, to an inner surface 2A (see FIG. 3) facing a vehicle inside (vehicle front side) of the rear bumper cover 2. As such, the decorative portion 6 also functions as a marker to inform the user of the position of the detection unit 5. Thus, the user recognizes that he or she should perform, using the decorative portion 6 on the left side as a marker, the kick motion as if holding his or her foot 9 under this decorative portion 6.

As illustrated in FIG. 3, the detection unit 5 includes a sensor 10 that is disposed to oppose the inner surface 2A of the rear bumper cover 2 and extends in the vehicle width direction, a controller 20 that processes a signal from the sensor 10, and a support member 30 that is fixed to the inner surface 2A of the rear bumper cover 2 and supports the sensor 10 and the controller 20. The support member 30 of the present embodiment is fixed to the inner surface 2A on the reverse side of the decorative portion 6. In addition, the sensor 10 of the present embodiment is at least partially disposed on the reverse side of the decorative portion 6.

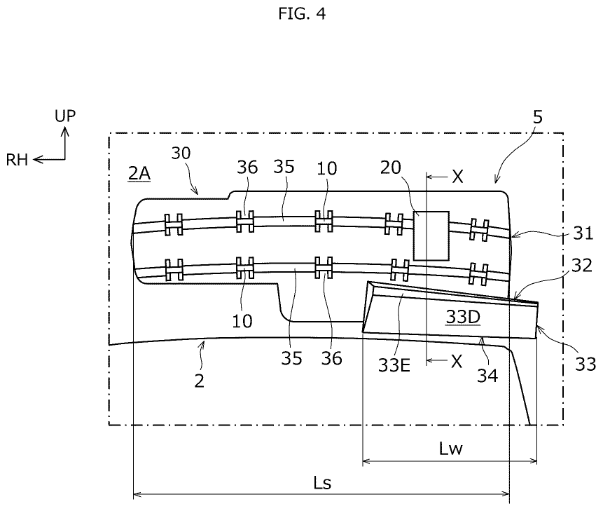

The sensor 10 detects the kick motion and is, for example, conventionally known capacitive sensor that detects an object on the basis of a change in capacitance. As illustrated in FIGS. 3 and 4, the sensor 10 of the present embodiment is disposed along a concave portion 35 of the support member 30 and is engaged with (fixed to) the support member 30 by multiple clips 36. Here, the detection unit 5 illustratively includes two sensors 10 arranged one above the other. A vehicle width directional dimension Ls of each sensor 10 of the present embodiment is approximately equal to a vehicle width directional dimension of a first surface portion 31 of the support member 30, which will be described later. The sensors 10 may be of any type, for example, those that use ultrasonic waves.

The controller 20 is an ECU (Electronic Control Unit) that processes signals (detection results) from the sensors 10. The controller 20 determines, based on values of the capacitance detected by the sensors 10 and/or a change in the values, existence and absence of the kick motion (determines whether or not the kick motion has performed). If the controller 20 determines that the kick motion has performed, the controller 20 outputs an open/close signal or a stop signal to a door ECU (not depicted). Based on this signal, the door ECU sends a signal to the electric motor to operate the tailgate. In the detection unit 5 of the present embodiment, the controller 20 is disposed toward the left (outside in the vehicle width direction). It should be noted that the drawings omit signal lines and power lines connected to the sensors 10 and the controller 20.

As illustrated in FIG. 3, the support member 30 is configured to include at least three surface portions 31, 32, and 33. The first surface portion 31 is a sheet-shaped portion to which the sensors 10 and the controller 20 are attached. The first surface portion 31 extends along the inner surface 2A of the rear bumper cover 2 in a state (hereinafter referred to as a “fixed state”) where the support member 30 is fixed to the rear bumper cover 2. The second surface portion 32 is a sheet-shaped portion positioned on a front side of the controller 20 and extends upward from a front end 31b of the first surface portion 31 in the fixed state. The third surface portion 33 is a sheet-shaped portion that extends downward from an upper end 32a of the second surface portion 32 and forms an erect wall 34 in a substantially inverted V shape with the second surface portion 32 in the fixed state.

The support member 30 of the present embodiment is made of resin, and the first surface portion 31, the second surface portion 32, and the third surface portion 33 are integrally formed. In addition to these surface portions 31 to 33, the support member 30 is provided with, for example, a bracket (not illustrated) for mounting the support member 30 on the rear bumper cover 2 and the like. The configuration of each of the surface portions 31 to 33 will be described in detail below.

The first surface portion 31 extends in the vehicle width direction along the inner surface 2A of a lower portion of the rear bumper cover 2. The first surface portion 31 is, for example, fastened and fixed to multiple bosses (not illustrated) formed on the inner surface 2A of the rear bumper cover 2. As illustrated in FIG. 3, the lower portion of the rear bumper cover 2 is inclined (or curved) to the front side as approaching down, and therefore the first surface portion 31 is inclined rearward such that a rear end 31a thereof on the upper side is positioned posterior to a front end 31b thereof on the lower side. Each of the sensors 10 is attached to a surface facing the rear and lower sides of the first surface portion 31 and the controller 20 is attached to a surface facing the front and upper sides of the first surface portion 31.

The first surface portion 31 is provided with the concave portions 35 and the clips 36 for fixing the sensors 10, and a fixing portion (not illustrated) for fixing the controller 20. The concave portions 35 are recessed toward the front side of the first surface portion 31, along a longitudinal direction (vehicle width direction) of the first surface portion 31. Since the detection unit 5 of the present embodiment is provided with the two sensors 10, the concave portions 35 are also formed at two locations, one above the other, on the first surface portion 31. The clips 36 are portions formed at multiple locations along the longitudinal direction of each of the concave portions 35 and serving as fasteners that clamp each of the sensors 10.

The second surface portion 32 is, as illustrated in FIG. 4, provided on a left part of the support member 30 so as to overlap with the controller 20 when viewed in a front-rear direction, in other words, so as to entirely cover the controller 20 in the vehicle width direction. As illustrated in FIG. 3, the second surface portion 32 is a substantially planar portion that extends in the vehicle width direction and obliquely forward and upward from the front end 31b extending in the vehicle width direction at a left part of the first surface portion 31. The second surface portion 32 tilts forward such that the upper end 32a thereof is positioned closer to the front side than a lower end 32b thereof. The lower end 32b of the second surface portion 32 is continuous with the lower end 31b at the left part of the first surface portion 31.

The third surface portion 33 is positioned at the furthest front in the support member 30 and is a substantially planar portion extending in the vehicle width direction. An upper end 33a of the third surface portion 33 is continuous with the upper end 32a of the second surface portion 32. The third surface portion 33 opposes the second surface portion 32 with a gap therebetween in the front-rear direction except at its upper end 33a, and separates further away from the second surface portion 32 as approaching down.

The third surface portion 33 of the present embodiment has an inclining surface 33D arranged in a forward tilting posture such that a lower end 33b thereof is positioned closer to the rear side than the upper end 33a thereof. The third surface portion 33 of the present embodiment is bent near the upper end 33a and is provided with a top surface 33E facing the front and upper sides between the upper end 33a and the inclining surface 33D. Incidentally, the top surface 33E may be omitted. In such a case, the entire third surface portion 33 serves as the inclining surface 33D.

Above the upper end 33a of the third surface portion 33, a vehicle body (e.g., a bumper beam 4, a rear floor panel, etc.) is positioned, but the third surface portion 33 (support member 30) is not connected to the vehicle body and a space is provided above the third surface portion 33. Since the support member 30 is separated from the vehicle body, no vibration is transmitted between the support member 30 and the vehicle body. In addition, providing the space contributes to enhanced outfitting. A gap for draining water is provided between the lower end 33b of the third surface portion 33 and the rear bumper cover 2.

The erect wall 34 has both a function of protecting the controller 20 against flying stones (including foreign objects such as trash and dirt) flying from the front side and diagonally below as indicated by solid arrows A in FIG. 3 and a function of preventing intrusion of air (oncoming wind during travel) from the front side into the inside of the rear bumper cover 2 as indicated by dashed arrows B in FIG. 3. The erect wall 34 is, as described above, formed by the second surface portion 32 and the third surface portion 33. As illustrated in FIG. 4, a vehicle width directional dimension Lw of the erect wall 34 of the present embodiment is equal to or shorter than a half of the vehicle width directional dimension Ls of each of the sensors 10.

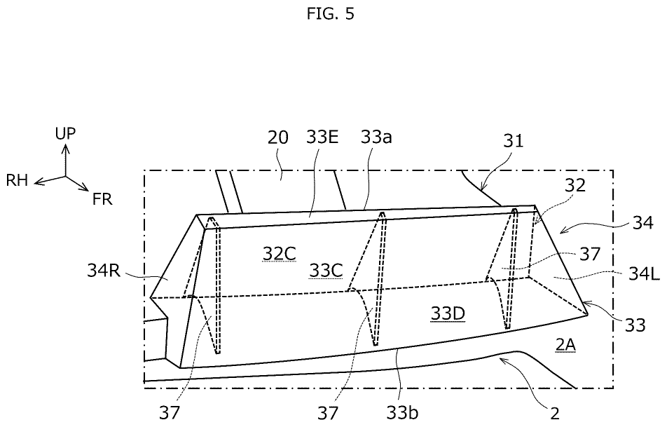

As illustrated in FIGS. 3 and 5, the support member 30 includes ribs 37 that each connect mutually opposing surfaces of the second surface portion 32 and the third surface portion 33, i.e., a front surface 32C facing the front side of the second surface portion 32 and a rear surface 33C facing the rear side of the third surface portion 33, to each other. The ribs 37 each have the same outer shape as a vertical cross-sectional shape of the erect wall 34 cut in the front-rear direction, and are each provided so as to span between the front surface 32C and the rear surface 33C. In the present embodiment, as illustrated in FIG. 5, multiple (three in this example) ribs 37 are arranged at intervals in the vehicle width direction. Although the erect wall 34 of the present embodiment includes a left end surface 34L and a right end surface 34R, these end surfaces 34L and 34R may be omitted.

### 2. Actions and Effects

(1) In the detection unit 5 described above, the support member 30, which supports the sensors 10 extending in the vehicle width direction and the controller 20, includes the first surface portion 31, the second surface portion 32, and the third surface portion 33. The first surface portion 31 to which the sensors 10 and the controller 20 are attached extends along the inner surface 2A of the rear bumper cover 2. The second surface portion 32 is positioned on the front side of the controller 20 and extends upward from the front end 32b of the first surface portion 31. The third surface portion 33 extends downward from the upper end 32a of the second surface portion 32 and forms the erect wall 34 in a substantially inverted V shape with the second surface portion 32.

Therefore, according to the detection unit 5 described above, the erect wall 34 prevents the oncoming wind from entering the rear bumper cover 2, thereby reducing the traveling resistance and thus, can satisfy the aerodynamic requirement. In addition, the erect wall 34 can protect the controller 20 from flying stones and thus, can satisfy the flying stones prevention requirement. In this regard, the erect wall 34 is formed by the second surface portion 32 and the third surface portion 33 and thus, can ensure high rigidity and prevent deformation due to the influence of the oncoming wind or flying stones. In addition, compared to Patent Document 1 mentioned in the Background Technique, the detection unit 5 described above does not require a large structure such as the rear floor cover and therefore can reduce costs.

(2) In the detection unit 5 described above, the first surface portion 31, the second surface portion 32, and the third surface portion 33 which are included in the support member 30 are integrally formed. Therefore, compared to a configuration in which separate parts are combined (assembled), the number of parts can be reduced, which can contribute to a further cost reduction.

(3) In addition, the support member 30 described above is provided with the ribs 37 that connect the front surface 32C of the second surface portion 32 and the rear surface 33C of the third surface portion 33 to each other. As a result, the ribs 37 span between the two opposing surfaces 32C and 33C and thus, can further increase the rigidity of the erect wall 34.

(4) The multiple ribs 37 are arranged at intervals in the vehicle width direction and therefore, can further increase the rigidity of the erect wall 34.

(5) The third surface portion 33, which is at the furthest front among the three surfaces 31 to 33, receives the oncoming wind and flying stones, but in the support member 30 described above, the third surface portion 33 is provided with the inclining surface 33D arranged in the forward tilting posture. As a result, even if foreign objects rolled up by a rear wheel 3 flies diagonally upward to the rear side, the inclining surface 33D is likely to receive the foreign objects. In addition, the airflow from the front side is easily deflected by the inclining surface 33D, making it easier to achieve both the aerodynamic requirement and the flying stones prevention requirement.

(6) In the detection unit 5 described above, the vehicle width directional dimension Lw of the erect wall 34 described above is equal to or shorter than a half of the vehicle width directional dimension Ls of the sensor 10, so that it is possible to achieve both the aerodynamic requirement and the flying stones prevention requirement while keeping component size small.

(7) Further, in the detection unit 5 described above, the support member 30 is fixed to the reverse side of the decorative portion 6 of the rear bumper cover 2 and at least a portion of the sensors 10 is disposed on the reverse side of the decorative portion 6. Therefore, the decorative portion 6 can be used as a marker for the kick motion, thereby enhancing convenience for the user. In addition, this eliminates the need to provide a dedicated marker for the kick motion, which contributes to an enhanced appearance (designability).

(8) In the vehicle lower structure described above, the decorative portion 6 is provided as the convex portion or the concave portion forming the predetermined shape. Therefore, the decorative portion 6 can increase the rigidity of the rear bumper cover 2 in addition to enhancing the designability and functioning as a marker for the detection unit 5 described above.

### 3. Modifications

The configuration of the detection unit 5 described above is merely an example and is not limited to the above.

For example, the support member 30 described above is integrally formed by the first surface portion 31, the second surface portion 32, and the third surface portion 33, but alternatively, the support member 30 may be configured by these surfaces 31 to 33 separately provided and combined afterward. In this case, the lower end 32b of the second surface portion 32 and the lower end 31b at the left part of the first surface portion 31 may be connected to each other, and the upper end 33a of the third surface portion 33 and the upper end 32a of the second surface portion 32 may be connected to each other.

The dimension and arrangement of each part are also examples. For example, three or more sensors 10 extending in the vehicle width direction may be arranged side by side along the vertical direction, or only one sensor 10 may be provided. Alternatively, instead of the sensors 10 extending in the vehicle width direction, multiple sensors in, for example, dot shapes may be arranged along the vehicle width direction to enable detection over a broad area. The configuration for supporting the sensors 10 on the support member 30 is also not limited to the concave portions 35 and the clips 36.

The controller 20 may be disposed near the center in the vehicle width direction or to the right of the first surface portion 31. The position of the fixing portion provided on the first surface portion 31 and the position of the erect wall 34 (the second surface portion 32 and the third surface portion 33) may be set according to the position of the controller 20.

The vehicle width directional dimension Lw of the erect wall 34 only needs to be large enough to entirely cover at least the controller 20 on the rear side of the rear wheel 3, and may be set longer than a half of the vehicle width directional dimension Ls of each sensor 10.

The third surface portion 33 described above is provided with the inclining surface 33D in the forward tilting posture, but this may be omitted. For example, even without the inclining surface 33D arranged in the forward tilting posture such that its lower end is positioned closer to the vehicle rear side than its upper end, i.e., even if the third surface portion 33 extends in a substantially vertical direction, the advantageous effect described in (1) of [2. Actions and Effects] above can be obtained. Further, the ribs 37 are also not essential and can be omitted.

The detection unit 5 described above is disposed on the reverse side of the decorative portion 6 on the left side, but may alternatively be disposed on the reverse side of another decorative portion 6. The shape, number, and arrangement of the decorative portions 6 are merely examples and are not limited to those described above. The detection unit 5 described above may be mounted on a vehicle with no decorative portion 6.

### INDUSTRIAL APPLICABILITY

The present disclosure is applicable to industries of manufacturing detection units that are attached to rear bumper covers and detect kick motions by users and to industries of manufacturing vehicles equipped with these detection units.

### DESCRIPTION OF REFERENCE SIGN

1 Vehicle
2 Rear bumper cover
2A Inner surface
2B Rear surface
3 Rear wheel
4 Bumper beam
5 Detection unit
6 Decorative portion
9 Foot of user
10 Sensor
20 Controller
30 Support member
31 First surface portion
31a Rear end
31b Front end
32 Second surface portion
32a Upper end
32b Lower end
32C Front surface (opposing surface)
33 Third surface portion
33a Upper end
33b Lower end
33C Rear surface (opposing surface)
33D Inclining surface
33E Top surface
34 Erect wall
34L Left end surface
34R Right end surface
35 Concave portion
36 Clip
37 Rib
Ls Vehicle width directional dimension of sensor
Lw Vehicle width directional dimension of erect wall

1. A detection unit, which is attached to a rear bumper cover of a vehicle and detects a kick motion of a user, the detection unit comprising:
a sensor that is disposed to oppose an inner surface facing a vehicle inside of the rear bumper cover, extends in a vehicle width direction, and detects the kick motion;
a controller that processes a signal from the sensor; and
a support member that is fixed to the inner surface of the rear bumper cover and supports the sensor and the controller, wherein
the support member includes
a first surface portion to which the sensor and the controller are attached and which extends along the inner surface of the rear bumper cover in a fixed state,
a second surface portion that is positioned on a vehicle front side of the controller and extends upward from a front end of the first surface portion in the fixed state, and
a third surface portion that extends downward from an upper end of the second surface portion and forms an erect wall in a substantially inverted V shape with the second surface portion in the fixed state.

2. The detection unit according to claim 1, wherein
the first surface portion, the second surface portion, and the third surface are integrally formed.

3. The detection unit according to claim 1, wherein
the support member includes a rib that connects mutually opposing surfaces of the second surface portion and the third surface portion to each other.

4. The detection unit according to claim 3, wherein
a plurality of the ribs are arranged at intervals in the vehicle width direction.

5. The detection unit according to claim 1, wherein
the third surface portion includes an inclining surface arranged in a forward tilting posture such that a lower end thereof is positioned closer to a vehicle rear side than an upper end thereof.

6. The detection unit according to claim 1, wherein
a vehicle width directional dimension of the erect wall is equal to or shorter than a half of a vehicle width directional dimension of the sensor.

7. The detection unit according to claim 1, wherein
the rear bumper cover includes a decorative portion that is provided at a lower portion of a rear surface facing a vehicle rear side thereof and that forms a predetermined shape in a vehicle rear view,
the support member is fixed to the inner surface on a reverse side of the decorative portion, and
at least a portion of the sensor is disposed on the reverse side of the decorative portion.

8. A vehicle lower structure including the detection unit defined in claim 7, wherein
the decorative portion of the rear bumper cover is provided as a convex portion or a concave portion forming the predetermined shape.
